(19) United States
(12) Patent Application Publication
(10) Pub. No.: US 2008/0026090 A1
(43) Pub. Date: Jan. 31, 2008

(54) SHEET PUNCHING AND EMBOSSING MACHINE WITH ADJUSTABLE PUNCHING OR EMBOSSING PRESSURE

(75) Inventor: David EHRBAR, Walldorf (DE)

Correspondence Address: HEIDELBERGER DRUCKSMASCHINEN AKTIENGESELISCHAFT;C/O KEATING & BENNETT, LLP, 8180 GREENSBORO DRIVE, SUITE 850, MCLEAN, VA, 22102, US

(73) Assignee: HEIDELBERGER DRUCKMASCHINEN AG, Heidelberg (DE)

(21) Appl. No.: 11/779,495

(22) Filed: Jul. 18, 2007

(30) Foreign Application Priority Data
Jul. 26, 2006 (DE) 10 2006 034 509.6
Jul. 26, 2006 (DE) 10 2006 034 511.8
Mar. 26, 2007 (DE) 10 2007 014 317.8

(51) Int. Cl. B28B 11/14

(52) U.S. Cl. 425/302.1

(57) ABSTRACT

A sheet punching and embossing machine includes at least one punching station having an adjustable punching or embossing pressure and including a first platen fixed to a frame and a second platen that is arranged to be moved against the first platen. One of the platens is connected to a device that is arranged to regulate the punching and embossing pressure, and the device has several actuator elements, such as piezo-elements, hydraulic chambers, or electric motors, that are distributed over the entire device.

### BACKGROUND OF THE INVENTION

1. Field of the Invention

The present invention relates to a sheet punching and embossing machine with adjustable punching or embossing pressure.

2. Description of the Background Art

Sheet punching and embossing machines are rather well known in the prior art. Punching refers to a cutting process using closed, geometrical forms, which can be circular, oval, or polygonal, as well as special shapes of every kind. Practices in the post-processing of a print job, such as punching with a hollow punch, rounding corners, and register punching, are also included in this field. The punching is done against a base or against a punch, and sometimes there are also shearing processes (cf. Post-Processing, Training Manual for Bookbinders, Bundesverband Druck e.V. 1996, page 351 et seq.) involved. Packaging materials of paper, cardboard, paperboard or corrugated cardboard are primarily punched in sheet format. During the punching process, however, groove lines or blind imprints may also be introduced into the finished sheets. This complex process makes it essential to punch the sheets individually. Since the end products are packages with demanding technical and graphical requirements (such as those for cosmetics, cigarettes, medicines, foods, etc.), special requirements are placed not only on the packaging materials themselves, but it also requires punching dies with minimal tolerances and extremely precise and reliable punching machines for optimal results. These demands are best met by flatbed punches. The printed sheets, stacked on a pallet, are fed to the punch. In the machine, the sheets being punched are first oriented accurately in an orienting mechanism, picked up by a gripping cart and positioned exactly in the punching mechanism between a bottom table and a top table, and they are punched there. One of the tables can move, the other is stationary.

Various embodiments of punching stations for a punching machine are described in DE 30 44 083 C3. A punching station has two platens, also known as a top table and a bottom table. One of the two tables is movable, the other stationary. One table carries the punching die with the punching blades, the other table carries the counterplate. The moving table can be moved back and forth perpendicular to the plane of the counterplate by a drive device. A distinction is drawn between a bent lever drive and an eccentric drive for the drive devices. When the top table is the moving platen, it is connected to the machine frame by a yoke. DE 30 44 083 C3 describes, among other things, a punching machine with a top table driven by an eccentric gearing. In order to obtain products of high quality, it must be possible to adjust the punching pressure in the punching and embossing machine to the particular sheet being processed.

As described in DE 30 44 083 C3, this is done by displacement of wedge-shaped steel plates. These steel plates are located between eccentric shafts and the driven top table. The displacement of the wedge-shaped steel plates changes the distance between movable top table and fixed bottom table, and thus, the punching force.

A similar method for regulating the working pressure of a punching press is described in DE 691 05 804 T2. Shims are located beneath press beams, on which the bent lever drive of a moving bottom table is mounted. The shims can be displaced by electric/pneumatic or hydraulic motors, thus changing the vertical position of the press beams, and thus that of the bent lever drive and the moving platen. This changes the distance between bottom table and fixed top table, and thus the punching force.

Laid Open Application DE 24 48 814 shows a device for adjusting the parallelism of the moving platen of a platen press, and also for regulating the punching pressure of a platen press. The moving platen in this device is driven by a push rod/crank shaft device. The device is mounted on a bearing with trapezoidally shaped wedges. The sloping side of one wedge slides against the sloping side of the other wedge, so that this movement decreases or increases the overall height, depending on the direction of movement of the wedges. The device is mounted on four bearings with wedges. To regulate the punching pressure, all wedges have to be moved at the same time. This changes the spacing of the two platens and, thus, the punching force.

What is common to the different devices for adjusting the punching force in the prior art is that the punching force can only be set overall, i.e., in relation to the entire surface of the platen. Due to such a design, however, there is an unequal distribution of the punching force over the surface of the platen in all punching and embossing machines of the prior art. The punching force is introduced at individual power application points and thus does not press against the entire platen surface. Depending on the rigidity of the platen, a deformation of the top table and the bottom table will result, and this in turn produces an unequal distribution of the punching pressure over the surface of the platen. The unequal punching pressure, in turn, results in an unclean cutting of the knife blades of the punching die. In the prior art, this problem is solved in that the punching blades are individually padded. Depending on how much the punching force deviates from what is required, strips of paper or plastic of varying thickness are glued to the punching blades on the back side of the die. This so-called fitting-up is very time consuming and has to be done when the machine is idle. Depending on the number of punching blades and the shape being cut, the fitting process can last several hours. The high setup time results in very low machine productivity.

### SUMMARY OF THE INVENTION

In order to overcome the problems described above, preferred embodiments of the present invention provide a sheet punching and embossing machine having a shortened setup time, increased productivity and an adjustable punching or embossing pressure.

In one preferred embodiment of the present invention, a sheet punching and embossing machine includes at least one punching station having an adjustable punching or embossing pressure. A first platen of the punching station is fixedly mounted in the machine frame of the sheet punching and embossing machine, a second platen is movable and can be moved up against the first platen. A device arranged to regulate the punching and embossing pressure is connected to the first fixed platen.

In a further preferred embodiment of the present invention, the device arranged to regulate the punching or embossing pressure has roughly the same base surface as the first platen, is situated in a plane parallel or substantially parallel to the first platen, and is fastened on the fixed machine frame of the sheet punching and embossing machine.

The device arranged to regulate the punching or embossing pressure causes a deformation of the first platen and, thus, a movement of the first platen toward the second platen. Thus, the device enables an adjustment of the parallelism of the two platens, an adjustment of the levelness of the first platen, and a regulating of the punching or embossing pressure.

In a further preferred embodiment of the present invention, the device for regulating the punching or embossing pressure preferably includes several actuator elements.

In an especially preferred embodiment of the present invention, the actuator elements can be actuated individually.

In another especially preferred embodiment, the actuator elements are distributed over the entire device to regulate the punching or embossing pressure. The distribution of the actuator elements can be uniform or nonuniform.

In another preferred embodiment of the present invention, a sheet punching and embossing machine includes at least one punching station having an adjustable punching or embossing pressure, a first platen arranged fixedly in a machine frame and a second platen which can be moved up against the first platen, while the second platen is connected to a device arranged to regulate the punching and embossing pressure. The device has at least five, for example, actuator elements that are distributed over the surface of the device.

In an especially preferred embodiment, the actuator elements can be actuated individually.

In the above-described preferred embodiments with their respective further modifications, the punching or embossing pressure can be regulated during the operation of the sheet punching and embossing machine by the device that is arranged to regulate the punching or embossing pressure.

In an alternative preferred embodiment of the present invention, a sheet punching and embossing machine includes at least one punching station having an adjustable punching or embossing pressure with a first bottom platen arranged fixedly in a machine frame and a second top platen which can be moved up against the first platen, which is connected to the machine frame by a yoke, while a device arranged to regulate the punching and embossing pressure is located in each of the upright supports of the yoke. Each device has at least one actuator element, which can be actuated individually, and by which the punching or embossing pressure can be regulated during the operation of the sheet punching and embossing machine.

In all of the above-described preferred embodiments and their further modifications, the actuator elements can be electric motors, which are connected by a gearing to a device arranged to move or feed the platen. Alternatively, the actuator elements can be piezo-elements or hydraulic chambers.

If the sheet punching and embossing machine has a hot film embossing station, the device arranged to regulate the punching or embossing pressure can also be used advantageously to shut off the working stroke. Especially in a setup mode, when no sheet is present beneath the hot film module, it is necessary to shut off the working stroke to prevent the film from being placed on the embossing die and sticking to it.

Moreover, it is advantageous for the sheet punching and embossing machine to have separate drive units for the sheet transport system and the individual processing stations. The drive unit of the sheet transport system can be configured, in particular, as a linear drive.

Other features, elements, steps, characteristics and advantages of the present invention will be described below with reference to preferred embodiments thereof and the attached drawings.

### BRIEF DESCRIPTION OF THE DRAWINGS

FIG. 1 is a sheet punching and embossing machine with a device arranged to regulate the punching or embossing pressure.

FIG. 2a is a detailed view of the punching station.

FIG. 2b is a cross sectional view of FIG. 2a along line IIb-IIb.

FIG. 3a illustrates an actuator element embodied as a piezo-element.

FIG. 3b illustrates an actuator element embodied as a hydraulic chamber.

FIG. 3c illustrates an actuator element embodied as an electromechanical positioning device.

### DETAILED DESCRIPTION OF PREFERRED EMBODIMENTS

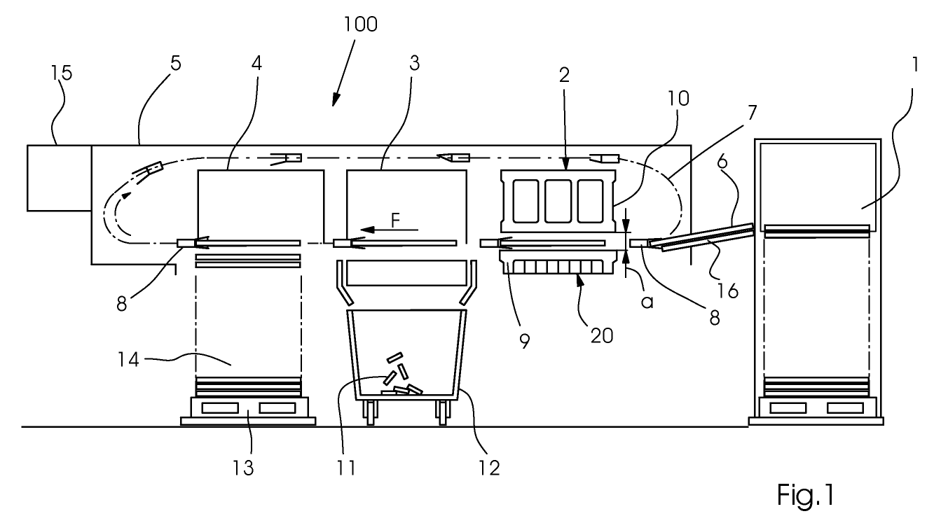

FIG. 1 shows the basic layout of a sheet punching and embossing machine 100 for the punching, detaching and delivery of sheets of paper, cardboard or the like. The punching and embossing machine 100 has an input unit 1, a punching station 2, a detaching station 3 and a delivery unit 4, which are carried and surrounded by a common machine housing 5.

The sheets 6 are taken singly from a stack by the input unit 1 and fed by a feeding table 16 to the sheet punching and embossing machine 100 and grabbed at their front edge by grippers of a gripping cart 8, fastened to a transport system 7, and intermittently pulled in the sheet delivery direction F through the various stations 2, 3, and 4 of the punching and embossing machine 100.

The punching station 2 preferably includes a bottom table 9 and a top table 10, which are spaced apart from each other by the distance a. The bottom table 9 is fixedly mounted in the machine frame and provided with a counterplate for the punching blade. The top table 10 is mounted such that it can move back and forth. The bottom table 9 is connected to a device arranged to regulate the punching and embossing pressure 20. This device 20 is preferably located between bottom table 9 and machine frame 5.

The gripping cart 8 transports the sheet 6 from the punching and embossing machine 2 to the following detaching station 3, which is outfitted with detachment dies. At the detaching station 3, the unneeded waste pieces from the sheet 6 are pushed downward by the detaching dies, so that the waste pieces 11 drop into a bin-like cart 12 underneath the station.

From the detaching station 3, the sheet goes to the delivery unit 4, where the sheet is either merely stacked, or a separation of the individual copy units can occur at the same time. The delivery unit 4 can also contain a pallet 13, on which the individual sheets are placed in the form of a stack 14, so that after reaching a certain stack height, the pallets with the stacked sheets 14 can be driven away from the area of the punching and embossing machine 100.

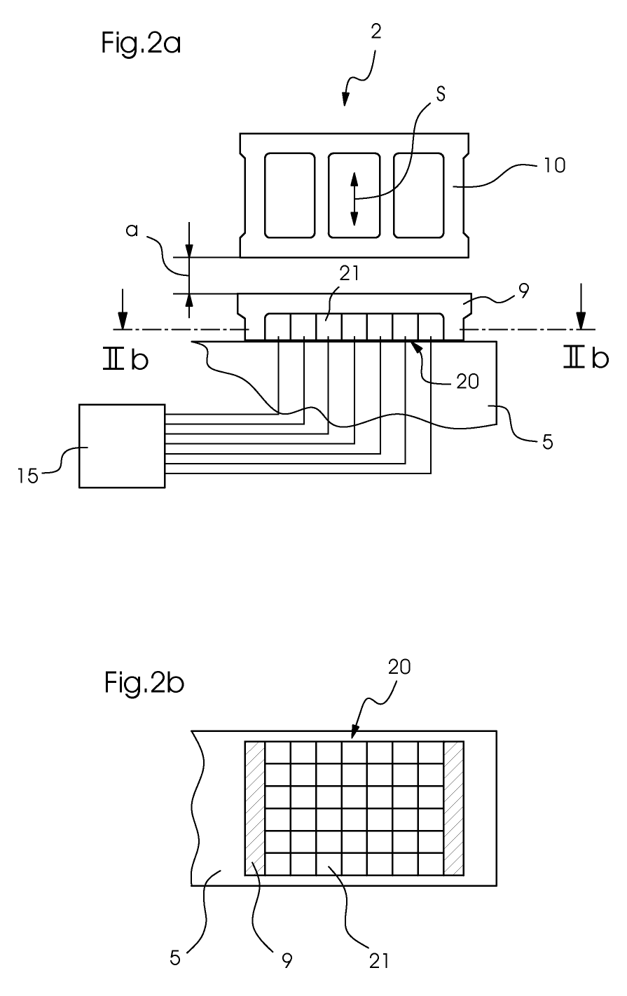

FIG. 2a shows a detailed view of the punching station 2 of the sheet punching and embossing machine 100. Top table 10 and bottom table 9 are spaced apart from each other by the distance a. The bottom table 9 is the fixed platen, the top table 10 is the movable platen, which executes a punching stroke S. The bottom table 9 is firmly connected to the machine housing 5 of the sheet punching and embossing machine 100. Located between the bottom table 9 and the machine housing 5 is the device arranged to regulate the punching or embossing pressure 20. This device 20 preferably includes several actuator elements 21. It is clear from FIG. 2b that the actuator elements 21 are distributed over the base surface of the device for regulating the punching or embossing pressure 20. The actuator elements 21 can be distributed, as shown, in a matrix fashion uniformly over the surface of the device for regulating the punching or embossing pressure 20, or also nonuniformly (not shown).

The actuator elements 21 of the device arranged to regulate the punching or embossing pressure 20 can be actuated individually. The actuation occurs via a control system 15.

The punching stroke S, i.e., the feeding of the top table 10 against the bottom table 9, is also actuated via the control system 15.

For better visibility, the punching station 2 is drawn without punching dies. The punching blades are joined to the top table 10 via a die frame. The bottom table 9 is connected to a counterpunch plate. The punching die can be designed in a manner familiar to a special design. Also, the gripping cart 8 and sheet 6 have been left out of this figure for sake of clarity. However, their position can be seen from FIG. 1.

If the actuator elements 21 of the device arranged to regulate the punching or embossing pressure 20 are actuated individually by the control system 15, they will act with a pressing force on the bottom table 9 and the counterpunch plate situated above it. The bottom table 9 and the counterpunch plate experience a minimal deformation from this. Thanks to this deformation, the spacing a of the top table from the bottom table can be adjusted by zone, i.e., the distance from the punching blade to the counterpunch plate and, thus, the punching pressure acting on a sheet 6 from a punching blade.

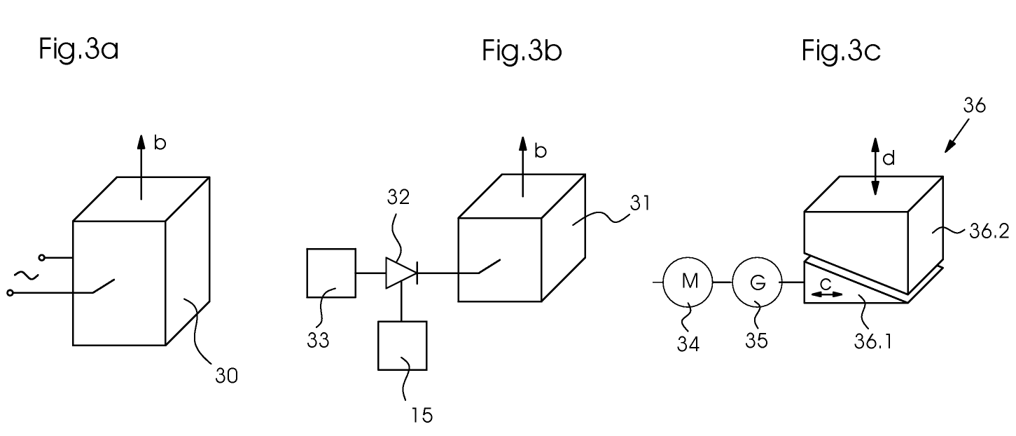

The actuator elements 21 of the device arranged to regulate the punching or embossing pressure 20 can be configured with different design alternatives. These are represented in FIGS. 3a, 3b and 3c. FIG. 3a shows a piezo-element 30, to which a voltage is applied, bringing about a deformation of the piezocrystals. Actuation of the piezo-element is done by controlling the voltage source. The piezo-element 30 is preferably designed such that the crystals extend primarily in the direction b. The extending of the piezocrystals in the direction perpendicular to the extension direction b, on the other hand, is prevented by the structure and the structural layout of the piezo-element 30.

FIG. 3b shows a hydraulic chamber 31 that is connected to a hydraulic assembly 33 by hose lines. Between hydraulic assembly 33 and hydraulic chamber 31 there is a valve 32. This is actuated by the control system 15. The hydraulic chamber 31 is structurally designed such that an increase in the pressure in the hydraulic chamber 31 extends the actuator element 21 in the extension direction b.

FIG. 3c shows an electromechanical positioning device 36 that preferably includes a first wedge 36.1 and a second wedge 36.2. The wedges 36.1 and 36.2 slide against each other along their respective slanted surfaces. The first and bottom wedge 36.1 can be moved in the positioning direction c by an electric motor 34 via a gearing 35. During the movement c, the second and upper wedge 36.2 slides on the bottom wedge 36.1 and is thus moved in the positioning direction d. Control of the actuator element 21 with electromechanical positioning device 36 takes place by actuating the electric motor 34.

The movement of the actuator elements 21 in the extension direction b or positioning direction d brings about a pressing force on the top table 9 each time.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A sheet punching and embossing machine comprising:
a frame;
at least one punching station having an adjustable punching or embossing pressure and including a first platen fixed to the frame and a second platen arranged to be moved against the first platen; and
a device arranged to regulate a punching pressure or an embossing pressure of the at least one punching station; wherein
the first platen is operatively connected to the device arranged to regulate the punching or embossing pressure.

2. The sheet punching and embossing machine according to claim 1, wherein the device arranged to regulate the punching or embossing pressure has approximately the same base surface as the first platen and is situated between the base surface of the first platen and the frame.

3. The sheet punching and embossing according to claim 1, wherein the device arranged to regulate the punching or embossing pressure is arranged to cause a deformation of the first platen and a feeding of the first platen toward the second platen.

4. The sheet punching and embossing machine according to claim 1, wherein the device arranged to regulate the punching or embossing pressure is arranged to regulate the punching or embossing pressure during the operation of the sheet punching and embossing machine.

5. The sheet punching and embossing machine according to claim 1, wherein the device arranged to regulate the punching or embossing pressure includes a plurality of actuator elements.

6. The sheet punching and embossing machine according to claim 5, wherein the plurality of actuator elements are arranged to be actuated individually.

7. The sheet punching and embossing machine according to claim 5, wherein the plurality of actuator elements are distributed over the entire device arranged to regulate the punching or embossing pressure.

8. The sheet punching and embossing machine according to claim 5, wherein the plurality of actuator elements are piezo-elements.

9. The sheet punching and embossing machine according to claim 5, wherein the plurality of actuator elements are hydraulic chambers.

10. The sheet punching and embossing machine according to claim 5, wherein the plurality of actuator elements are electric motors that are connected by a gearing to a positioning device.

11. A sheet punching and embossing machine comprising:
a frame;
at least one punching station having an adjustable punching or embossing pressure and including a first platen fixed to the frame and a second platen that is arranged to be moved against the first platen; and
a device arranged to regulate a punching pressure or an embossing pressure of the at least one punching station; wherein
the second platen is connected to the device arranged to regulate the punching or embossing pressure and the device arranged to regulate the punching or embossing pressure includes at least five actuator elements that are distributed over the entire device arranged to regulate the punching or embossing pressure.

12. The sheet punching and embossing machine according to claim 11, wherein the actuator elements are arranged to be actuated individually.

13. The sheet punching and embossing machine according to claim 11, wherein the device arranged to regulate the punching or embossing pressure is arranged to regulate the punching or embossing pressure during the operation of the sheet punching and embossing machine.

14. The sheet punching and embossing machine according to claim 11, wherein the actuator elements are piezo-elements.

15. The sheet punching and embossing machine according to claim 11, wherein the actuator elements are hydraulic chambers.

16. The sheet punching and embossing machine according to claim 11, wherein the actuator elements are electric motors that are connected by a gearing to a positioning device.

17. A sheet punching and embossing machine comprising:
a frame;
a yoke including supports;
at least one punching station having an adjustable punching or embossing pressure and including a first platen fixed to the frame and a second platen arranged to be moved against the first platen and connected to the frame by the yoke; and
a device arranged to regulate a punching pressure or an embossing pressure during operation of the sheet punching and embossing machine including at least one actuator element that can be actuated individually; wherein
the device arranged to regulate a punching or embossing pressure is located in each of the supports of the yoke.

18. The sheet punching and embossing machine according to claim 17, wherein the at least one actuator element is a piezo-element.

19. The sheet punching and embossing machine according to claim 17, wherein the at least one actuator element is a hydraulic chamber.

20. The sheet punching and embossing machine according to claim 17, wherein the at least one actuator element is an electric motor that is connected by a gearing to a positioning device.
